(19) United States
(12) Patent Application Publication
(10) Pub. No.: US 2025/0299850 A1
(43) Pub. Date: Sep. 25, 2025

(54) METHOD FOR ADJUSTING POSTURE OF TWISTED PAIR CABLE AND METHOD FOR PROCESSING TWISTED PAIR CABLE

(71) Applicants: TE Connectivity Solutions GmbH, Schaffhausen (CH); Tyco Electronics (Shanghai) Co., Ltd., Shanghai (CN)

(72) Inventors: An (Joshua) Yang, Shanghai (CN); Lvhai (Samuel) Hu, Shanghai (CN); Roberto Francisco-Yi Lu, Bellevue, WA (US)

(73) Assignees: TE Connectivity Solutions GmbH, Schaffhausen (CH); Tyco Electronics (Shanghai) Co., Ltd., Shanghai (CN)

(21) Appl. No.: 19/084,955

(22) Filed: Mar. 20, 2025

(30) Foreign Application Priority Data
Mar. 20, 2024 (CN) 202410323501.7

(51) Int. Cl. H01B 13/00; G06T 1/00; G06T 7/73; H01R 43/28

(52) U.S. Cl. CPC H01B 13/0036; G06T 1/0014; G06T 7/74; H01R 43/28

(57) ABSTRACT

A method for adjusting a posture of a twisted pair cable includes capturing an image of an end face of the cable and calculating the posture of twisted pair core wires of the cable at the end face based on the captured image. The method further includes calculating an initial posture of the core wires at a cutting position of a section of an outer layer of the cable to be peeled off based on the posture, a length of the section, and a twisting pitch of the cable. The method also includes calculating an adjustment angle that the cable needs to be rotated based on the initial posture and a predetermined posture of the core wires at the cutting position and rotating the cable around its central axis by the adjustment angle to adjust the posture of the core wires at the cutting position to the predetermined posture.

### CROSS-REFERENCE TO RELATED APPLICATION

This application claims the benefit of the filing date under 35 U.S.C. § 119 (a)-(d) of Chinese Patent Application No. CN202410323501.7 filed on Mar. 20, 2024.

### FIELD OF THE INVENTION

The present invention relates to a method for adjusting the posture of a cable and a method for processing a cable and, more particularly, to a method for adjusting the posture of a twisted pair cable and a method for processing a twisted pair cable.

### BACKGROUND OF THE INVENTION

In the prior art, in order to electrically connect one end of a twisted pair cable to the terminal of a connector, an outer layer from the twisted pair cable must first be removed to expose the inner twisted pair core wires. The twisted pair of core wires are then unwound and straightened. Finally, the straightened twisted pair core wires are adjusted to a predetermined posture by rotating the twisted pair cable, for example, to a horizontal posture (i.e., the connection line between the centers of twisted pair core wires is horizontal) or a vertical posture (i.e., the connection line between the centers of twisted pair core wires is vertical), in order to facilitate subsequent processes. In the prior art, it is necessary to adjust the twisted pair core wires to the predetermined posture based on visual inspection after peeling off the section of the outer layer and straightening the twisted pair core wires. However, it is not possible to accurately determine the adjustment angle required to adjust the twisted pair core wires to the predetermined posture before peeling off the section of the outer layer and straightening the twisted pair core wires. This brings many inconveniences to the processing of twisted pair cables and reduces the processing efficiency and accuracy of twisted pair cables.

### SUMMARY OF THE INVENTION

A method for adjusting a posture of a twisted pair cable includes capturing an image of an end face of the twisted pair cable and calculating the posture of twisted pair core wires of the twisted pair cable at the end face based on the captured image. The method further includes calculating an initial posture of the twisted pair core wires at a cutting position of a section of an outer layer of the twisted pair cable to be peeled off based on the posture of the twisted pair core wires at the end face, a length of the section, and a twisting pitch of the twisted pair cable. The method also includes calculating an adjustment angle that the twisted pair cable needs to be rotated based on the initial posture and a predetermined posture of the twisted pair core wires at the cutting position and rotating the twisted pair cable around its central axis by the adjustment angle to adjust the posture of the twisted pair core wires at the cutting position to the predetermined posture.

### BRIEF DESCRIPTION OF DRAWINGS

The invention will now be described by way of example with reference to the accompanying figures, of which:

FIG. 1 is a perspective view of a twisted pair cable according to an exemplary embodiment;

FIG. 2 is a perspective view of using a camera to capture an image of an end face of the twisted pair cable of FIG. 1;

FIG. 3 is a plan view of a calculated posture of twisted pair core wires of the twisted pair cable of FIG. 1 at the end face of FIG. 2 based on the captured image of FIG. 2;

FIG. 4 is a perspective view of the twisted pair core wires of FIG. 3 in which a twisting pitch of the twisted pair cable of FIG. 1 and a length of a section of an outer layer of the twisted pair cable of FIG. 1 to be peeled off are shown;

FIG. 5 is a plan view of an initial posture of the twisted pair core wires of FIG. 3 at a cutting position;

FIG. 6 is a schematic view of clamping the twisted pair cable of FIG. 1 with a cable fixture according to an exemplary embodiment;

FIG. 7 is a schematic view of rotating the twisted pair cable of FIG. 1 to a predetermined posture by rotating the cable fixture of FIG. 6;

FIG. 8 is a schematic view of using a cutting tool to cut the outer layer of FIG. 4;

FIG. 9 is a schematic view of using a stripping fixture to remove the cut outer layer of FIG. 8 from the twisted pair cable of FIG. 1;

FIG. 10 is a schematic view of the twisted pair cable of FIG. 1 with the section of the cut outer layer of FIG. 8 peeled off;

FIG. 11 is a schematic view of straightening the exposed twisted pair core wires of FIG. 3; and

FIG. 12 is a plan view of the end face of FIG. 2 after the twisted pair core wires of FIG. 3 are straightened.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

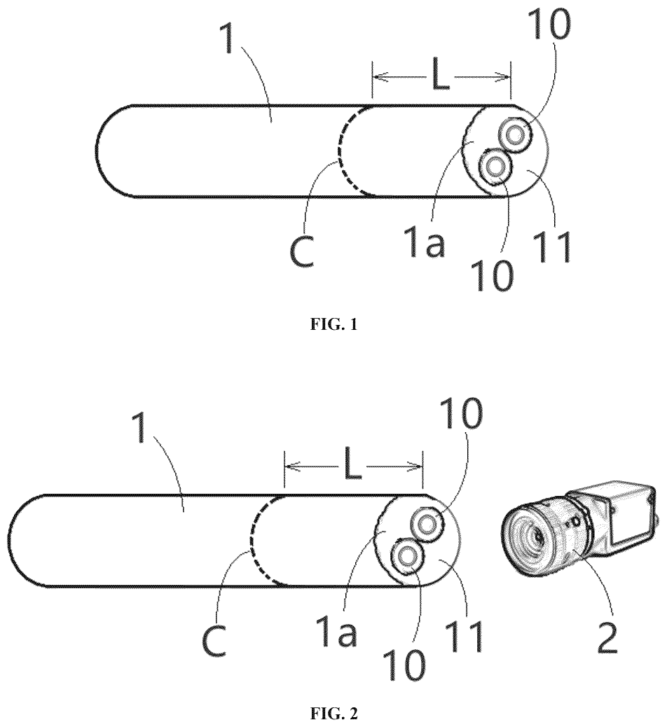

An exemplary embodiment of a method for adjusting the posture of a twisted pair cable will now be described with reference to FIGS. 1-5 and 7. As shown in FIG. 2, the method for adjusting the posture of the twisted pair cable includes a step S11: taking an image of the end face 1a of the twisted pair cable 1. In step S11, the camera 2 set in front of the end face 1a of the twisted pair cable 1 is used to capture an image of the end face 1a of the twisted pair cable 1 along the axial direction of the twisted pair cable 1.

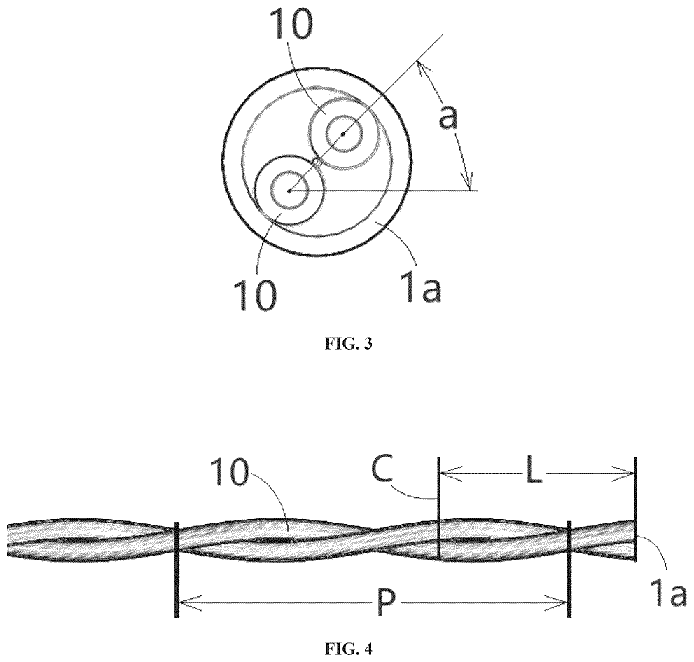

As shown in FIG. 3, the method for adjusting the posture of the twisted pair cable further includes a step S12: calculating the posture of the twisted pair core wires 10 of the twisted pair cable 1 at the end face 1a based on the captured image. In step S12, a first angle a, as shown in FIG. 3, between the connection line between the centers of twisted pair core wires 10 of the twisted pair cable 1 and a predetermined orientation is calculated based on the captured image of the end face 1a of the twisted pair cable 1 to determine the posture of the twisted pair core wires 10 of the twisted pair cable 1 at the end face 1a. The predetermined orientation is a horizontal or vertical orientation perpendicular to the central axis of the twisted pair cable 1.

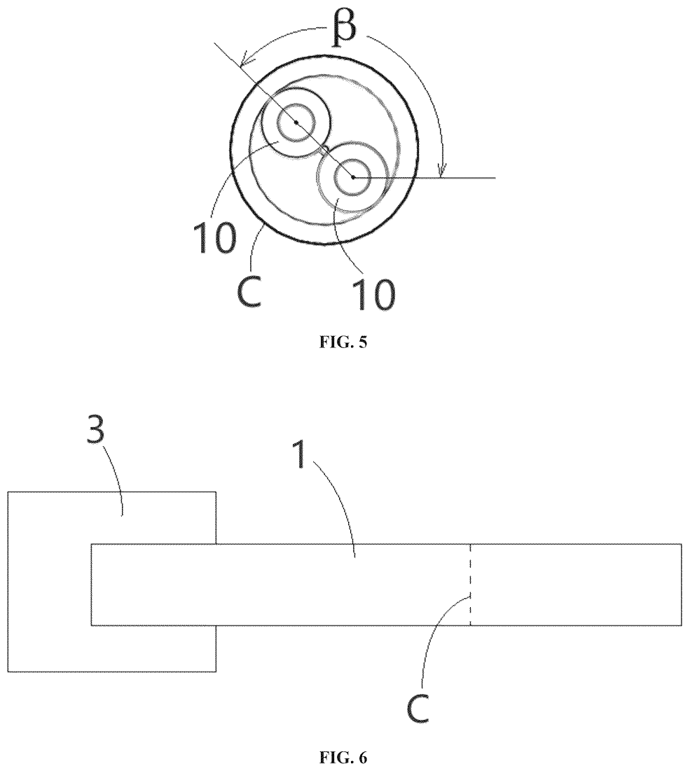

The method for adjusting the posture of the twisted pair cable, as shown in FIGS. 3-5, further includes a step S13: calculating an initial posture of the twisted pair core wires 10 at the cutting position C of a section of the outer layer 11 to be peeled off based on the posture of the twisted pair core wires 10 at the end face 1a, the length L of the section of the outer layer 11 to be peeled off from the twisted pair cable 1, and the twisting pitch P of the twisted pair cable. In step S13, a second angle β between the connection line between the centers of twisted pair core wires 10 of the twisted pair cable 1 at the cutting position C of the section of outer layer 11 to be peeled and the predetermined orientation is calculated, according to the following formula: β=a+L/P×360°, to determine the initial posture of the twisted pair core wires 10 of the twisted pair cable 1 at the cutting position C of the section of the outer layer 11 to be peeled off. As shown in FIG. 3, the first angle a is the first angle between the connection line between the centers of twisted pair core wires 10 of the twisted pair cable 1 and the predetermined orientation. The second angle β, as shown in FIG. 5, is the second angle between the connection line between the centers of twisted pair core wires 10 of the twisted pair cable 1 at the cutting position C of the section of the outer layer 11 to be stripped and the predetermined orientation. As shown in FIGS. 1-2 and 4, L is the length of the section of the outer layer 11 to be peeled off from the twisted pair cable 1. The twisting pitch P, as shown in FIG. 4, is the twisting pitch of the twisted pair cable 1.

The method for adjusting the posture of the twisted pair cable further includes a step S14: calculating the adjustment angle that the twisted pair cable needs to be rotated based on the initial posture of the twisted pair core wires 10 at the cutting position C of the section of the outer layer 11 to be peeled off and the predetermined posture of the twisted pair core wires 10 at the cutting position C of the section of the outer layer 11 to be peeled off. In step S14, the adjustment angle is set to the second angle β.

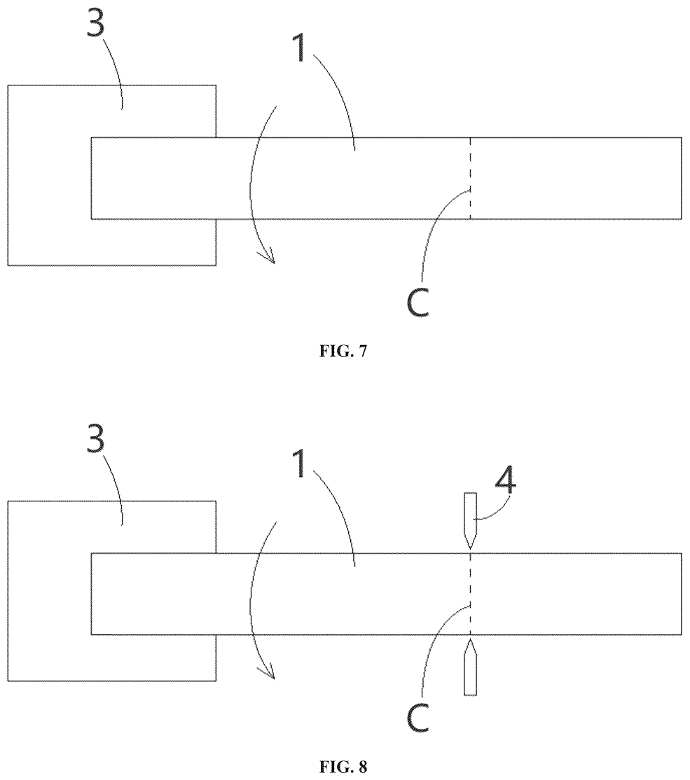

As shown in FIG. 7, the method for adjusting the posture of the twisted pair cable further includes a step S15: rotating the twisted pair cable 1 around its central axis by the adjustment angle, so that the posture of the twisted pair core wires 10 at the cutting position C of the section of the outer layer 11 to be peeled off is adjusted to the predetermined posture. In step S15, the twisted pair cable 1 is rotated by the second angle β around its central axis, so that the connection line between the centers of twisted pair core wires 10 of the twisted pair cable 1 at the cutting position C of the section of the outer layer 11 to be peeled off is in a predetermined orientation, thereby adjusting the posture of the twisted pair core wires 10 of the twisted pair cable 1 at the cutting position C of the section of the outer layer 11 to be peeled off to the predetermined posture.

An exemplary embodiment of a method for processing a twisted pair cable will now be described with reference to FIGS. 1-12. The method for processing the twisted pair cable includes a step S21: using the aforementioned method for adjusting the posture of the twisted pair cable to adjust the twisted pair cable 1 to the predetermined posture, as shown in FIGS. 1-5 and 7. As shown in FIGS. 6-7, in step S21, the twisted pair cable 1 is clamped with the cable fixture 3 and the posture of the twisted pair cable 1 is adjusted to a predetermined posture by rotating the cable fixture 3.

As shown in FIGS. 8 and 10, the method for processing the twisted pair cable further includes a step S22: cutting the outer layer 11 radially at the cutting position C of the outer layer 11 of the twisted pair cable 1, and peeling off the cut outer layer 11 from the twisted pair cable 1.

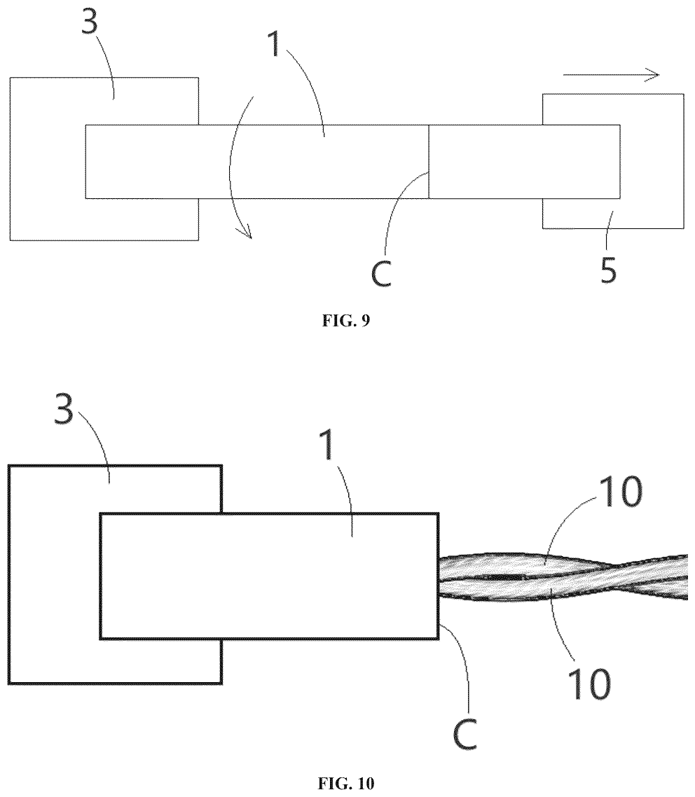

As shown in FIG. 8, Step S22 includes a step S221: aligning the cutting edge of a cutting tool 4 radially with the cutting position C of the section of the outer layer 11 to be peeled off from the twisted pair cable 1, and moving the cutting tool 4 radially towards the outer layer 11 to cut it radially. As shown in FIGS. 9-10, step S22 further includes a step S222: using a peeling fixture 5 to clamp the cut outer layer 11 and pull it outward along the axial direction of the twisted pair cable 1, so that the cut outer layer 11 is peeled off from the twisted pair cable 1.

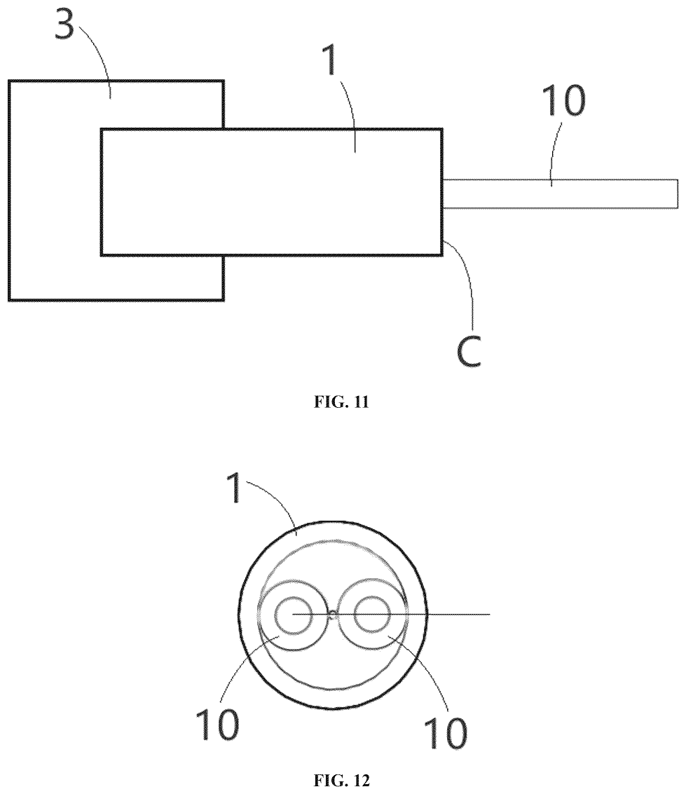

The method for processing the twisted pair cable, as shown in FIGS. 11-12, further includes a step S23: straightening the exposed twisted pair core wires 10 of the twisted pair cable 1 so that the connection line between the centers of exposed twisted pair core wires 10 of twisted pair cable 1 is parallel to the predetermined orientation.

In the aforementioned exemplary embodiments according to the present invention, the adjustment angle required to adjust the twisted pair core wires 10 of the twisted pair cable 1 to a predetermined posture can be accurately determined before peeling off the section of the outer layer 11 of the twisted pair cable 1, thereby improving the processing efficiency and accuracy of the twisted pair cable 1.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

1. A method for adjusting a posture of a twisted pair cable, comprising:
capturing an image of an end face of the twisted pair cable;
calculating the posture of twisted pair core wires of the twisted pair cable at the end face based on the captured image;
calculating an initial posture of the twisted pair core wires at a cutting position of a section of an outer layer of the twisted pair cable to be peeled off based on the posture of the twisted pair core wires at the end face, a length of the section, and a twisting pitch of the twisted pair cable;
calculating an adjustment angle that the twisted pair cable needs to be rotated based on the initial posture and a predetermined posture of the twisted pair core wires at the cutting position; and
rotating the twisted pair cable around its central axis by the adjustment angle to adjust the posture of the twisted pair core wires at the cutting position to the predetermined posture.

2. The method of claim 1, wherein in the capturing step, a camera set in front of the end face captures an image of the end face along an axial direction of the twisted pair cable.

3. The method of claim 1, wherein in the calculating the posture step, a first angle of a connection line between centers of the twisted pair core wires at the end face with respect to a predetermined orientation is calculated based on the captured image of the end face to determine the posture of the twisted pair core wires at the end face.

4. The method of claim 3, wherein in the calculating an initial posture step, a second angle of a connection line between the centers of the twisted pair core wires at the cutting position with respect to the predetermined orientation is calculated according to the following formula β=a+L/P×360° to determine the initial posture of the twisted pair core wires at the cutting position, in which a is the first angle of the connection line between the centers of the twisted pair core wires at the end face with respect to the predetermined orientation, B is the second angle of the connection line between the centers of the twisted pair core wires at the cutting position with respect to the predetermined orientation, L is the length of the section of the outer layer to be peeled off from the twisted pair cable, and P is the twisting pitch of the twisted pair cable.

5. The method of claim 4, wherein in the calculating an adjustment angle step, the adjustment angle is set to the second angle.

6. The method of claim 5, wherein in the rotating step, the twisted pair cable is rotated around its central axis by the second angle such that the connection line between the centers of the twisted pair core wires at the cutting position is in the predetermined orientation, thereby adjusting the posture of the twisted pair core wires at the cutting position to the predetermined posture.

7. The method of claim 3, wherein the predetermined orientation is a horizontal orientation perpendicular to the central axis of the twisted pair cable.

8. The method of claim 3, wherein the predetermined orientation is a vertical orientation perpendicular to the central axis of the twisted pair cable.

9. A method for processing a twisted pair cable, comprising:
adjusting a posture of the twisted pair cable by capturing an image of an end face of the twisted pair cable, calculating the posture of twisted pair core wires of the twisted pair cable at the end face based on the captured image, calculating an initial posture of the twisted pair core wires at a cutting position of a section of an outer layer of the twisted pair cable to be peeled off based on the posture of the twisted pair core wires at the end face, a length L of the section, and a twisting pitch of the twisted pair cable, calculating an adjustment angle that the twisted pair cable needs to be rotated based on the initial posture and a predetermined posture of the twisted pair core wires at the cutting position, and rotating the twisted pair cable around its central axis by the adjustment angle to adjust the posture of the twisted pair core wires at the cutting position to the predetermined posture;
cutting the outer layer radially at the cutting position; and
stripping the cut outer layer from the twisted pair cable.

10. The method of claim 9, further comprising, after the stripping step, straightening an exposed portion of the twisted pair core wires such that a connection line between centers of the twisted pair core wires are parallel to a predetermined orientation.

11. The method of claim 9, wherein the adjusting the twisted pair cable step further comprises clamping the twisted pair cable before the rotating step.

12. The method of claim 9, wherein the cutting step includes aligning a cutting edge of a cutting tool radially with the cutting position of the outer layer and moving the cutting tool radially towards the outer layer to radially cut the outer layer.

13. The method according of claim 9, wherein the stripping step includes using a peeling fixture to clamp the cut outer layer and pulling the cut outer layer outward along an axial direction of the twisted pair cable to peel the cut outer layer off the twisted pair cable.
